(19) United States
(12) Patent Application Publication
(10) Pub. No.: US 2003/0018460 A1
(43) Pub. Date: Jan. 23, 2003

(54) Method to preserve comments of circuit simulation text file

(76) Inventor: Chun-Chih Yang, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,041

(22) Filed: Jun. 4, 2002

(30) Foreign Application Priority Data
Jul. 20, 2001 (TW) 090117751

(51) Int. Cl. G06F 17/50

(52) U.S. Cl. 703/14

(57) ABSTRACT

A computer algorithm is provided for converting text files to circuit design databases so that a user can update the circuit design database and corresponding text file. The method comprises: compiling the hardware description in a text file to the corresponding circuit design database; compiling the comment text in the text file to a code stream according to a predetermined conversion rule; updating the circuit design database and compiling the updated circuit design database to the corresponding hardware description; and compiling the code stream to the comment text, and inserting the comment text to the hardware description corresponding to the updated circuit design database so as to generate an updated text file.

### BACKGROUND OF INVENTION

1. Field of the Invention

The present invention relates to a method to preserve comment text of a circuit simulation text file, and more particularly, to a method to preserve comment text by converting the comment text into a code stream according to a predetermined conversion rule.

2. Description of the Prior Art

Due to the development of semiconductor technology, it is an important objective in modern information society development to use electrical circuits to process various data composed of electrical signals. Mobile phones, personal computers, central processing units, and so on are built using various complex electrical circuits. In order to deal with more and more complex circuit designs, it is a trend to aid the circuit design with computer systems. The digital electrical circuits and logic circuits for processing digital data are widely used, and their circuit structures can be modularized. Therefore, the information industry takes an active interest in developing the technology of the digital circuit design with the aid of computer systems. That is, the circuit design is simulated and debugged by computer systems, which improves the performance of the circuits.

Please refer to FIG. 1. FIG. 1 is a flow chart of a prior art computer aided design (CAD) system. When utilizing a computer aided design system, a user (such as an R&D engineer) writes a hardware description 14A, together with a suitable comment text 14B, in a text file 14. The hardware description 14A is used to describe a specific design of the circuit design, such as circuit devices, logic blocks, and connections between each circuit device. The comment text 14B is used to record important issues of the circuit design, such as a special application of a circuit device, or an idea of the circuit design. Following that, the user can use a computer system to operate an electronic design aided tool (EDA tool) 12 to read in the text file 14. The EDA tool 12 can compile the hardware description 14A of the text file 14 into a corresponding circuit design database 16. Thus, the user can simulate the action of the circuit design database 16, and update, improve, and debug the circuit design database 16 through the EDA tool 12. After properly updating the circuit design database 16, the user can use the EDA tool 12 to compile the updated circuit design database 16 into a corresponding hardware description 18A, and then output another text file 18. Therefore, the user can preserve or understand the updated circuit design database 16 through the hardware description 18A.

Please refer to FIG. 2. FIG. 2 is a diagram for illustrating an example of the text file 14. According to a specification of Verilog hardware description language, the hardware description 14A describes an AND gate of dual iutputs as shown in FIG. 2. Therein, “AND2” represents a type of a circuit unit; “name” represents an identification name; “A(In1)” represents an input port A of the circuit unit; “B(In2)” represents an input port B of the circuit unit, and “Y(out)” represents an output port Y of the circuit unit. In order to improve flexibility of the specification of Verilog hardware description language, a white space can be inserted into the hardware description. The white space comprises a composition of some of space codes, tab codes, and enter codes. The space code is a white space occupying a space of a character, the tab space is a white space occupying a space of several characters, and the enter code is use to make a sentence enter into a new line. As shown in FIG. 2, space codes 20, tab codes 22, and enter codes 24 are included in the hardware description 14A. The EDA tool 12 will ignore the white space while compiling the hardware description 14A into the circuit design database 16. Accordingly, any white space in the text file 14 is of no effect on the operating results of the EDA tool 12. For example, the enter code 24 is inserted behind “AND2” in the hardware description 14, so that “name” and its following description enter into a new line. After the EDA tool 12 updating the circuit design database, the updated circuit design database is the same as that corresponding to the hardware description without adding the enter code 24 behind “AND2”.

Since the hardware description must conform to a specification of a language, its format is inflexible and its readability is poor. Thus, the user is always allowed to add the comment text in text files. As shown in FIG. 2, there are two comment texts 14B in the text file 14. One is the comment text of a single line beginning with “//”. The other is the comment text of a plurality of lines beginning with “/*” and ending with “*/”. The user can utilize the comment texts for explaining a circuit design rule, an application of a circuit, an application of a circuit device (or a logic block), or a specific function of a circuit device. Those explanations are hardly understood from the hardware description. The readability of the hardware description is therefore improved after adding the comment texts. With the aid of the comment texts, the user can quickly capture the circuit structure, and understand the circuit design rule without reading the complicated hardware description.

However, during the simulation process of the circuit design, the comment texts 14B will not be preserved after the EDA tool 12 compiles the text file 14 into the circuit design database 16 as shown in FIG. 1. After the user utilizes the EDA tool 12 to update the circuit design database 16 and compile circuit design database 16 into the corresponding hardware description 18A, then the comment texts 14B disappear. As the EDA tool 12 converts the hardware description 18A into the text file 18, the text file 18 does not include any comment texts.

Because the comment texts cannot be preserved in the prior art, the readability of the hardware description 18A in the text file 18 is poor, and the circuit design rules described in the comment texts cannot be kept. Thus, the knowledge, information, and experiences of the circuit design cannot be preserved. The lack of comment texts will have a bad influence on the development of the circuit design technology.

### SUMMARY OF INVENTION

It is therefore a primary objective of the claimed invention to provide a method to preserve comment text of a circuit simulation text file so as to overcome the above-mentioned problems.

A computer algorithm is provided to convert text files to circuit design databases so that a user can update the circuit design database and corresponding text file. The method comprises: compiling the hardware description in a text file to the corresponding circuit design database; compiling the comment text in the text file to a code stream according to a predetermined conversion rule; updating the circuit design database and compiling the updated circuit design database to the corresponding hardware description; and compiling the code stream to the comment text, and inserting the comment text to the hardware description corresponding to the updated circuit design database so as to generate an updated text file.

It is an advantage of the claimed invention that the comment texts can be preserved. The corresponding information of the circuit design can be kept, which improves the accumulation of the knowledge and the experiences of the circuit design and reinforces the ability of the research and development (R&D) in the information industry.

These and other objectives and advantages of the claimed invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a flow chart of a prior art computer aided design (CAD) system.

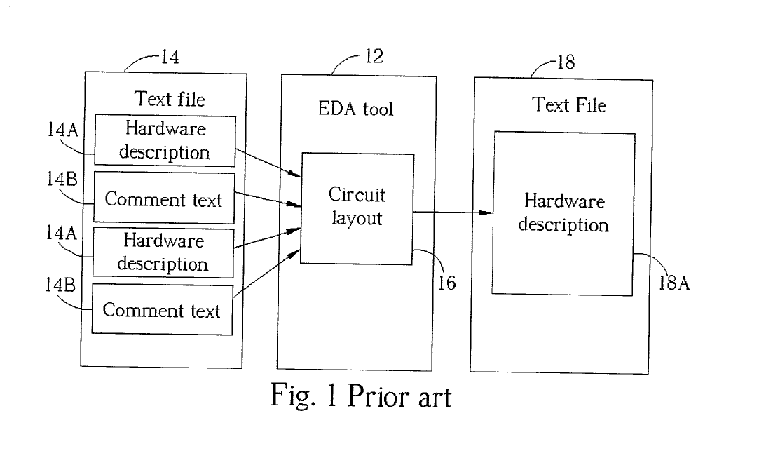

FIG. 2 is a diagram for illustrating an example of a text file.

FIG. 3 is a flow chart of a computer aided design system according to the present invention.

FIG. 4 is a flow chart for illustrating compiling comment texts into code streams according to the present invention.

FIG. 5 is a flow chart for illustrating compiling the code streams into corresponding comment texts.

### DETAILED DESCRIPTION

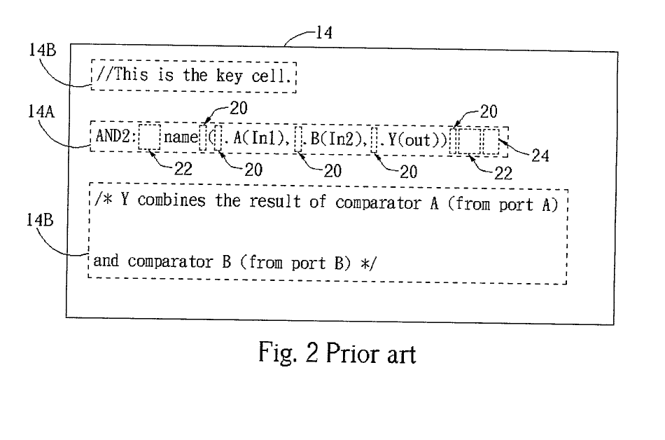

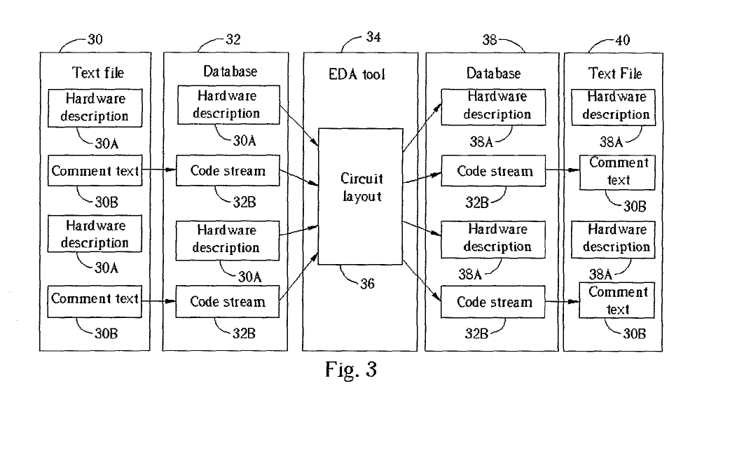

Please refer to FIG. 3. FIG. 3 is a flow chart of a computer aided design system according to the present invention. Firstly, a user has to use a specific hardware description language, such as a Verilog hardware description language, to describe a circuit design as a hardware description 30A in a text file 30. Data of circuit design rules or relationships between circuit devices are recorded in comment texts 30B. The comment texts 30B can be inserted into the hardware description 30A. As shown in FIG. 3, the text file 30 includes two comment texts 30B for conveniently illustrating the present invention. Furthermore, the text file 30 can include several comment texts 30B. A basic structure of the text file 30 is similar to that of the text file 14 as shown in FIG. 2. Thus, according to the present invention, the user can preserve the comment texts after operating the EDA tool without changing a way to write the hardware description and the comment texts.

According to the present invention, the comment texts 30B are first converted into the corresponding code streams 32B according to a predetermined conversion rule. The code streams 32B are stored in a data container 32, which is a storing apparatus such as a memory or a hard disk drive. In addition, the hardware description 30A is stored in the data container 32 without any change. As described above, a general hardware description language comprises several flexibly added codes, such as space codes, tab codes, and enter codes. The space codes, tab codes, and enter codes represent white spaces of the Verilog hardware description language. Those white spaces can be randomly added into the text file, but the EDA tool will ignore those white spaces and directly compile the hardware description into the corresponding circuit design database 36. As a result, the present invention replaces characters of the comment texts with a combination of those flexibly added codes. Thus, the comment texts are transformed into the corresponding code steams. Taking the Verilog hardware description language as an example, the present invention can replace characters of the comment texts with a combination of space codes, tab codes, and enter codes. Thus, the comment texts are transformed into the corresponding code steams. The details for compiling the comment texts into the code streams are further discussed as follows.

When compile all the comment texts 30B in the text file 30 into the corresponding code streams 32B in the data container 32, the hardware description 30A in the data container 32 can be read through the EDA tool 34 and be compiled into the corresponding circuit design database 36. The user can therefore simulate the action of the circuit design database 36 through the EDA tool 34. In addition, the user can update, debug, and improve the design of the circuit design database 36 through the EDA tool 34. As described above, each code stream 32B in the data container 32 is a combination of some of the codes, which the EDA tool 34 ignores (such as space codes, tab codes, and enter codes). The EDA tool 34 ignores the code streams 32B, and processes instructions of the hardware description 30A, which conforms to the specification of the hardware description language. As a result, the code streams 32B are preserved as the EDA tool 34 compiles the hardware description 30A into the circuit design database 36.

As the user outputs the updated circuit design database 36 from the EDT tool 34, the EDA tool 34 compiles the updated circuit design database 36 into the corresponding hardware description 38A. Then, the hardware description 38A and the code streams 32B, which are ignored by the EDA tool 34, are output into a data container 38. Thereafter, the code streams 32B in the data container 38 are compiled into the corresponding comment texts 30B according to the above-mentioned predetermined conversion rule. The comment texts 30B and the hardware description 38A are stored in the text file 40. Thus, the purpose of the present invention for preserving the comment texts is achieved.

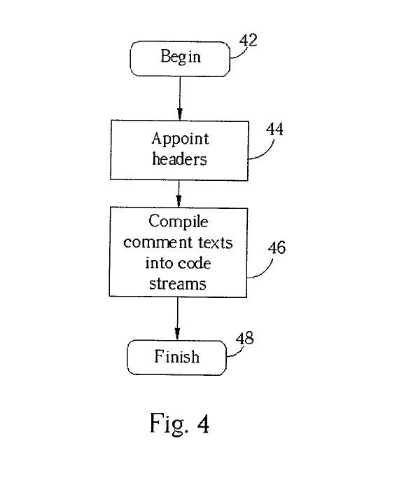

Please refer to FIG. 4. FIG. 4 is a flow chart for illustrating compiling the comment texts 30B into the code streams 32 according to the present invention. The detailed steps are described as follows:

Step 42:

Begin to compile the comment texts 30B. The following description assumes that the present invention is applied on the Verilog hardware description language. The EDA tool 34 shown in FIG. 3 ignores any white spaces of a combination of some of space codes, tab codes, and enter codes. Therefore, the present invention uses space codes, tab codes, and enter codes to compile the comment texts into the code streams.

Step 44:

Appoint a header of each code stream. The text file comprises several comment texts. For example, the text file shown in FIG. 3 includes two comment texts. In order to identify each of the comment texts dispersed in the text file, a header is located ahead of each code stream for identifying a starting position of each code stream in the data container. The header is a combination of some of the codes that the EDA tool 34 ignores, so that the header is preserved after processing the EDA tool 34.

When using the Verilog hardware description language, the header is a combination of space codes, tab codes, and enter codes. When making a header, any combination of space codes, tab codes, and enter codes can be firstly selected as a header. For example, a header can be described as “space code”, “tab code”, and “space code”, and another header can be described as “tab code”, “tab code”, “tab code”, and “enter code”. If any header is the same arrangement as the one in the text file, the header is deleted. As shown in FIG. 2, the hardware description 14A comprises “space code”, “tab code”, and “enter code”, and thus the arrangement of “space code”, “tab code”, and “enter code” cannot be selected as a header. Conversely, if an arrangement of codes hasn't appear in the text file, the arrangement of codes can be selected as a header for identifying a starting position of each code stream. Because there are infinite combinations of codes, there are a lot of available headers. As a result, suitable headers, which do not appear in the text file, can be selected in this step.

Step 46:

Compile the comment texts into the corresponding code streams according to the predetermined conversion rule. That is, all the characters of the comment texts are converted into the corresponding combination of codes. When using the Verilog hardware description language, each comment text is replaced with a combination of space codes, tab codes, and enter codes to form the corresponding code stream. For example, the character “a” in the comment texts can be replaced with “space code” and “enter code”, and the character “b” can be replaced with “space code”, “space code”, and “enter code”, and the character “c” can be replaced with “space code”, “space code”, “space code” and “enter code”. Therefore, the comment texts 30B in the text file 30 shown in FIG. 3 can be converted into the corresponding code streams 32B in the data container 32. Each code stream 32B is a combination of codes that the EDA tool 34 ignores, and thus each code stream 32B can be preserved after processing the EDA tool 34. Therefore, the comment texts are preserved.

Step 48:

Finish compiling the comment texts 30B. After completing the above-mentioned steps, the comment texts 30B in the text file 30 shown in FIG. 3 are therefore converted into the corresponding code streams 32B, which together with the hardware description 30A are stored in the data container 32.

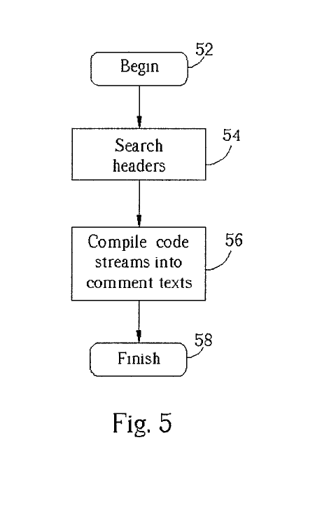

After processing the EDA tool 34, the code streams 32B together with the updated hardware description 38A are stored in the data container 38. As the code streams 32B in the data container 38 are converted into the original comment texts 30B, the flow shown in FIG. 5 is processed. Please refer to FIG. 5. FIG. 5 is a flow chart for illustrating compiling the code streams into the corresponding comment texts. The detailed steps are described as follows:

Step 52:

Begin to compile the code streams 32B. After the EDA tool 34 generates the Hardware description 38A and code stream 32B (please refer to FIG. 3), the following steps are started to convert the code streams 32B in the data container 38 into the corresponding comment texts 30B.

Step 54:

Search the headers in the data container 38. As mentioned in the flow of FIG. 4, a header is located ahead of each code stream corresponding to each comment text for identifying a starting position of the code stream. Therefore, while compiling the code streams 32B into the corresponding comment texts 30B, it has to first search the headers in the data container 38 for identifying the position of each code streams 32B.

Step 56:

Compile the identified code streams into the corresponding comment texts according to the above-mentioned conversion rule. As mentioned in the step 46 of FIG. 4, the “space code”, and “enter code” can be converted to the character “a” in the comment texts. As a result, the codes streams can be converted into the corresponding characters according to the conversion rule. For example, the code stream of “space cod”, “space code”, and “enter code” is converted into the character “b” in the comment texts. Accordingly, the code streams can be compiled into the corresponding comment texts.

Step 58:

Finish compiling the code streams 32B. After converting the code streams 32B in the data container 38 into the corresponding comment texts 30B that are then stored in the text file 40, the above-mentioned steps are completed.

The comment texts 30B, converted through the flow of FIG. 5, together with the hardware description 38A are stored in the text file 40. Accordingly, the user can not only keep the updated hardware description, but also can read the comment texts 30B in the text file 40. Therefore, the readability of the hardware description is improved and important information such as circuit design rules is preserved. The knowledge and the experiences of the circuit design can be accumulated, which improves the circuit design technology.

There are lots of ways to implement the present invention. When processing the flow of FIG. 3, a program of a computer system can be executed to operate the compiling process shown in FIG. 4 to form the data container 32. Then, the data container 32 is sent to the EDA tool 34 to process the circuit simulation. Then, another program is executed to process the flow shown in FIG. 5 to compile the data container 38 into the corresponding text file 40, wherein the data container 38 is output from the EDA tool 34. Reasonably, if the function of the EDA tool 34 permits, the text file 30 can be directly compiled into the data container 32 in the EDA tool 34, and the circuit simulation can be directly processed on the data container 32 by the EDA tool 34. Then, compiling the data container 38 into the text file 40 can also be performed in the EDA tool 34. As a result, the user can use the EDA tool 34 to read the text file 30 and to output the text file 40 that preserves the comment texts.

In the prior art, the comment texts cannot be preserved after processing the EDA tool. As a result, in comparison with the prior art, the comment texts can be preserved according to the flow and the method of the present invention. The corresponding information of the circuit design can be kept, which improves the accumulation of the knowledge and the experiences of the circuit design and reinforces the ability of the research and development (R&D) in the information industry.

The above disclosure is based on the preferred embodiment of the present invention. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A computer algorithm for converting a text file into a circuit design database and vice versa so that a user can update the text file and the corresponding circuit design database;
the computer algorithm comprising:
compiling a hardware description written in the text file into the corresponding circuit design database;
converting comment text written in the text file into a code stream according to a predetermined conversion rule;
updating the circuit design database and compiling the updated circuit design database into the corresponding hardware description; and
converting the code stream into the comment text, and inserting the comment text into the hardware description corresponding to the updated circuit design database so as to generate an updated text file.

2. The computer algorithm of claim 1 wherein a format of the comment text is different from a format of the code stream after being converted according to the predetermined conversion rule.

3. The computer algorithm of claim 1 wherein the text file conforms to a specification of a Verilog hardware description language.

4. The computer algorithm of claim 3 further comprising applying an electronic design aided tool (EDA) to compile the hardware description into the corresponding circuit design database, and updating the circuit design database through the electronic design aided tool.

5. The computer algorithm of claim 1 wherein the code stream comprises space codes, tab codes, or enter codes.

6. The computer algorithm of claim 1 further comprising:
generating a header attached before the code stream for indicating a starting point of the code stream.

7. The computer algorithm of claim 6 wherein the header comprises space codes, tab codes, or enter codes.

8. The computer algorithm of claim 1 wherein the code stream is stored in a data container.

9. The computer algorithm of claim 8 wherein the data container is stored in a memory.

10. The computer algorithm of claim 8 wherein the data container is stored in a hard disk drive.
